(19) United States
(12) Patent Application Publication
(10) Pub. No.: US 2018/0251065 A1
(43) Pub. Date: Sep. 6, 2018

(54) LIGHTING APPARATUS FOR VEHICLES

(71) Applicant: Hella KGaA Hueck & Co., Lippstadt (DE)

(72) Inventor: Martin Kappelhoff, Soest (DE)

(21) Appl. No.: 15/906,843

(22) Filed: Feb. 27, 2018

(30) Foreign Application Priority Data
Mar. 1, 2017 (DE) 102017104287.3

(51) Int. Cl. B60Q 1/076; B60Q 1/18; B60Q 1/068

(52) U.S. Cl. CPC B60Q 1/076; B60Q 1/18; F21S 41/39; B60Q 2200/36; B60Q 2200/32; B60Q 1/068

(57) ABSTRACT

A lighting apparatus for vehicles with a housing containing a main lighting module for creating a specified main lighting function and an auxiliary lighting module for creating an auxiliary lighting function. The auxiliary lighting module can be brought into an aligned adjustment position using at an adjusting device. The auxiliary lighting module can be brought into the adjustment position relative to the main lighting module using an adjusting device. Situated in the adjustment position is a cut-off line of the auxiliary lighting module relative to a cut-off line of the main lighting module. The auxiliary lighting module and the main lighting module are fastened to a common carrier member, which is mounted such that it can be swiveled relative to the housing.

### CROSS REFERENCE

This application claims priority to German Application No. 10 2017 104287.3, filed 1 Mar. 2017, the entirety of which is hereby incorporated by reference.

### FIELD OF THE INVENTION

The invention concerns a lighting apparatus for vehicles with a housing containing a main lighting module for creating a specified main lighting function and an auxiliary lighting module for creating an auxiliary lighting function. The auxiliary lighting module can be brought into an aligned adjustment position using an adjusting device.

### BACKGROUND OF THE INVENTION

Familiar from DE 10 2012 111 639 A1 is a lighting apparatus for vehicles that is enclosed by a housing, in which are located, first, a main lighting module for creating a main lighting function and, second, an auxiliary lighting module for creating an auxiliary lighting function, for example, a curve lighting function. As a static lighting module, the auxiliary lighting module is firmly connected to the housing and is always activated when the auxiliary lighting function is desired. The main lighting module is usually fastened to a carrier member, which can be moved relative to the housing by means of an adjusting device. In this way, headlamp leveling can be applied to the main lighting module. Even when the auxiliary lighting module is rigidly fastened to the housing, it has to be aligned by an adjusting device during assembly. The adjustment is required to compensate for tolerances relative to the main lighting module.

### SUMMARY OF THE INVENTION

The task of the present invention is to further develop a lighting apparatus for vehicles with a main lighting module and an auxiliary lighting module in such a way that the lighting function is easily expanded.

To solve this task, an embodiment of the invention is characterized by the fact that the auxiliary lighting module can be brought into the adjustment position relative to the main lighting module using the adjusting device; situated in the adjustment position is a cut-off line for the auxiliary lighting module relative to a cut-off line for the main lighting module; and by the fact that the auxiliary lighting module and the main lighting module are fastened to a common carrier member, which is mounted such that it can be swiveled relative to the housing.

According to the invention, an auxiliary lighting module is fastened together with a main lighting module of a lighting apparatus on the same carrier member, which is mounted such that it can be swiveled relative to the housing. The auxiliary lighting module can be brought into an adjustment position relative to the main lighting module using an adjusting device; in the adjustment position, the auxiliary lighting module is aligned relative to the main lighting module. According to the invention, during operation of the lighting apparatus the auxiliary lighting module is always in a fixed position relative to the main lighting module, so that it is swiveled horizontally and/or vertically along with the main lighting module. The auxiliary lighting module can be switched on and off along with the main lighting module, or it can be switched to the switched-on main lighting module to enable improved illumination, for example, of a roadside. A consequent advantage is that the main lighting function can be expanded by switching the auxiliary lighting module.

According to a preferred design embodiment of the invention, a mechanical movement conversion device is provided as an adjusting device for the auxiliary lighting module; the mechanical movement conversion device comprises a linear adjusting element, which acts upon the auxiliary lighting module by making an adjustment relative to the carrier member, and comprises a swivel mounting point to rotate the auxiliary lighting module about a rotational axis relative to the main lighting module and/or carrier member. This entails converting the linear actuation direction of the linear adjusting element into rotational movement of the auxiliary lighting module relative to the carrier member and/or main lighting module, so as to enable alignment of a cut-off line for the auxiliary lighting module relative to a cut-off line for the main lighting module for a basic setting of the lighting apparatus.

In an advanced embodiment of the invention, the linear adjusting element is linearly guided and mounted in a guide of the carrier member; the linear adjusting element has a ball end that is held in a ball holder of the auxiliary lighting module. A consequent advantage is that the auxiliary lighting module can be easily swiveled.

In an advanced embodiment of the invention, the linear element is designed as a threaded bolt, which is located in a thread engagement relative to the guide of the carrier member. A consequent advantage is that the auxiliary lighting module can be adjusted relatively exactly relative to the main lighting module by the rotational actuation of the linear adjusting element.

In an advanced embodiment of the invention, the auxiliary lighting module and the main lighting module are arranged by the common carrier member so that they can be adjusted synchronously. When adjusting devices act on the carrier member such that the main lighting module and the auxiliary lighting module are adjusted and/or swiveled simultaneously and by the same angle, the auxiliary lighting module can be easily switched if a correspondingly expanded lighting function is desired.

In an advanced embodiment of the invention, the auxiliary lighting module has a dimmable light source, which enables the auxiliary lighting function produced by the auxiliary lighting module to be adapted to currently desired light distributions. In particular, when the main lighting module and auxiliary lighting module are switched on, the illuminance of the overlapping main and auxiliary lighting functions can be adapted to a resulting lighting function in a peripheral area of the same.

In an advanced embodiment of the invention, the auxiliary lighting module is designed as a curve lighting module. Activation of the auxiliary lighting module can create better illumination when the main lighting function is set for country road or town lighting. Thus the curve lighting module is used not only for the actual purpose of the same, namely, a curve lighting function, but also to support the main lighting function. Thus the curve lighting module has multiple functions. First, the curve lighting module can be switched on or switched when the vehicle is navigating a curve. Second, the curve lighting module can be switched to the main lighting module when expanded illumination is desired for the main lighting function in a horizontal direction. In this case, the main and auxiliary lighting functions overlap to form a resulting lighting function, which has a larger horizontal width expansion than the main light distribution.

In an advanced embodiment of the invention, adjusting devices are coupled to, first, the housing and, second, the carrier member, so that the carrier member can be adjusted about a horizontal and/or vertical axis. This ensures headlamp leveling of the main lighting function; when the auxiliary lighting module is switched to the main lighting function, the illumination of the main lighting function can be expanded in the horizontal direction.

In an advanced embodiment of the invention, the swivel mounting point is formed by a convex contact face of the auxiliary lighting module and by a concave contact face of the carrier member, so that the auxiliary lighting module can be adjusted over an acute angular range, preferably in the vertical direction about a horizontal axis.

In an advanced embodiment of the invention, the guide of the carrier member is formed by a sleeve-like threaded part, which is firmly connected to the carrier member. A consequent advantage is that the linear element can be adjusted when the adjusting element is sufficiently loosened.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows the front view of a carrier member of the lighting apparatus (according to the present invention), to which an auxiliary lighting module is coupled.

FIG. 2 shows a side view of the carrier member.

FIG. 3 shows a horizontal cutaway in an area where the auxiliary lighting module is connected to the carrier member along reference line III-III in FIG. 1.

FIG. 4 shows a vertical cutaway through the area where the auxiliary lighting module is connected to the carrier member along reference line IV-IV in FIG. 1.

FIG. 5 shows a rear view of the area where the auxiliary lighting module is connected to the carrier member.

FIG. 6 shows a front view of the area where the auxiliary lighting module is connected to the carrier member.

FIG. 7 shows an exploded view of adjusting devices for adjusting the auxiliary lighting module relative to the carrier member.

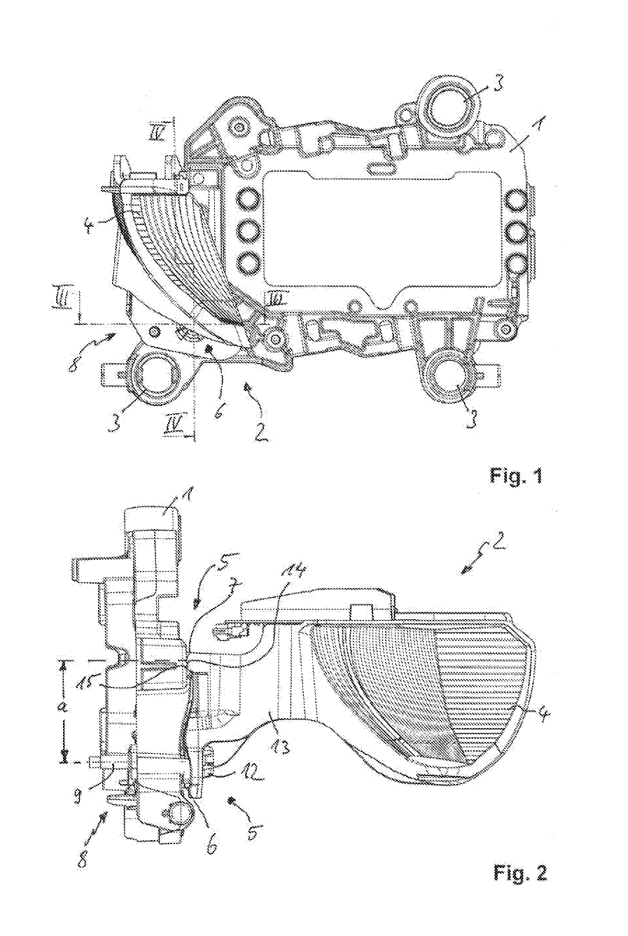

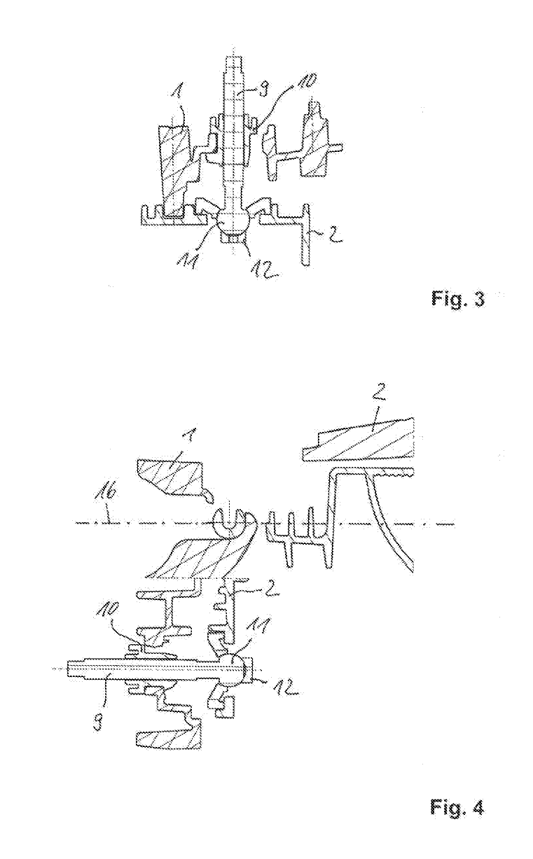

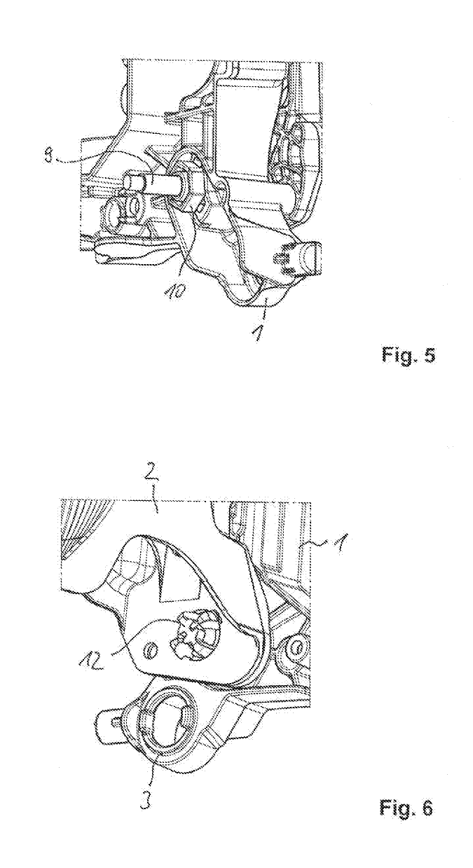

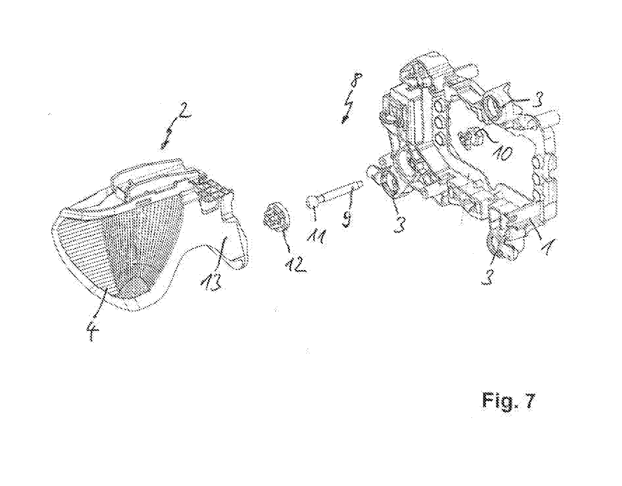

### DETAILED DESCRIPTION OF THE DRAWINGS

A lighting apparatus (according to the present invention) for vehicles can be designed in particular as a headlamp, which is located in a front-end area of the vehicle.

The headlamp comprises a housing, in which is located a carrier member, designed as the carrier frame 1. The carrier frame 1 is mounted by an adjusting device (not pictured) that allows for adjustment about a horizontal and/or vertical axis relative to the housing.

Fastened to the carrier frame 1 is, first, a main lighting module (not pictured) for creating a specified main lighting function and, second, a partially pictured auxiliary lighting module 2 for creating an auxiliary lighting function. For this purpose, the carrier frame 1 has mounting points 3, at which the main lighting module (not pictured) is mounted in the familiar way. The main lighting module is preferably fastened to the carrier frame 1 by a three-point mounting, whereby the main lighting module can be swiveled about a horizontal axis by corresponding actuation of the adjusting devices, so that headlamp leveling is ensured. The main lighting function can, for example, be a low-beam function. The main lighting module can, as usual, have a light source and an optical unit, whereby the optical unit contains, for example, a reflector. Where appropriate, the main lighting module can also have a projection module containing a light source, reflector, cover and lens.

The auxiliary lighting module 2, which has a light source (not pictured) and a reflector 4, is fastened to the carrier frame 1 by multiple mounting points 5. The mounting points 5 are formed by a mounting point 6 that is linearly adjustable, preferably in the horizontal direction, and a second mounting point 7 (swivel mounting point) located a distance a away from the same. At the mounting points 6, 7 of the auxiliary lighting module 2 on the carrier frame 1 are located adjusting devices for bringing the auxiliary lighting module 2 into a position relative to the main lighting module during assembly of the auxiliary lighting module 2, whereby the adjustment is made when the basic setting of the main lighting module and/or auxiliary lighting module 2 is configured. The adjustment position of the auxiliary lighting module 2 is reached when a cut-off line of the auxiliary lighting module 2 is aligned with a cut-off line of the main lighting module, such that the former is located at the same height as the latter. For this purpose, the mounting point 6 and the swivel mounting point 7 of the auxiliary lighting module 2 are vertically aligned one over the other, so that when the adjusting device at mounting point 6 is actuated, it is possible for the auxiliary lighting module 2 to swivel about a horizontal axis 16, which runs through the swivel mounting point 7. Thus an imaginary line connecting the mounting point 6 and the swivel mounting point 7 runs in the vertical direction.

A mechanical movement conversion device is provided as an adjusting device, by means of which the auxiliary lighting module 2 is swiveled about the horizontal axis by linear adjustment of an adjusting element. As an adjusting element, the adjusting device or mechanical movement conversion device 8 essentially comprises a linear adjusting element 9 located at the first mounting point 6 and contact faces 14, 15 located at the second swivel mounting point 7.

The linear adjusting element 9 is designed as a threaded bolt, which is located in a thread engagement relative to a guide 10 (longitudinal guide) of the carrier frame 1. The longitudinal guide 10 is designed as a sleeve-like threaded part, which is firmly connected to the carrier frame 1. The threaded bolt 9 has an external thread, through which it is in a thread engagement with an internal thread of the sleeve-like threaded part 10.

The threaded bolt 9 has a ball end 11 at an end facing the auxiliary lighting module 2; the ball end is mounted in a ball holder 12 of the auxiliary lighting module 2. The ball holder 12 is designed as an articulated element, which enables the linear adjusting element 9 to swivel relative to the auxiliary lighting module 2, particularly in the vertical direction. Due to the ball joint connecting the linear adjusting element 9 and the auxiliary lighting module 2, it is possible for the auxiliary lighting module 2 to swivel with a vertical and horizontal component of motion.

The threaded part 10 is fastened to the carrier frame 1 by a bayonet closure. The ball holder 12 is firmly connected to a swivel section 13 of the auxiliary lighting module 2 by a snap-in connection.

The ball holder 12 is connected to the ball end 11 by latching. The ball end 11 can be swiveled in the vertical and/or horizontal direction of motion relative to the ball holder 12.

Furthermore, the swivel section 13 has a convex contact face 14 in the area of the swivel mounting point 7 that acts together with a flat or concave contact face 15 of the carrier frame 1. The curvature of the contact face 14, 15 runs vertically to ensure that at the swivel mounting point 7 the auxiliary lighting module 2 swivels about the horizontal axis 16 relative to the carrier frame 1.

For adjustment of the auxiliary lighting module 2 relative to the main lighting module and/or the carrier frame 1, the linear adjusting element 9 is actuated manually or by a tool at an end facing away from the auxiliary lighting module 2. The linear adjusting element 9 is actuated when it is rotated about its longitudinal axis, so that, after thread engagement with the guide 10, the auxiliary lighting module 2 is moved away from or towards the carrier frame 1 along the axis of the linear adjusting element 9. Due to the design of the swivel mounting point 7, the auxiliary lighting module 2 swivels about the horizontal axis 16, which runs through the swivel mounting point 7. The adjustment position of the auxiliary lighting module 2 is reached once a cut-off line of the auxiliary lighting module 2 is aligned with a cut-off line of the main lighting module. Now the adjustment process is completed. The headlamp can be used in accordance with its intended use.

During operation of the headlamp, the auxiliary lighting module 2 is adjusted synchronously with the main lighting module and/or the carrier member 1. This is accomplished by the corresponding adjusting devices acting at at least one mounting point 3 of the carrier frame 1. The auxiliary lighting module 2 is preferably designed as a curve lighting module, the use of which enables lateral illumination of an area in front of the vehicle. To support the main lighting function, the auxiliary lighting module 2 or the curve lighting module can be switched to the main lighting module, so that wider illumination is ensured in the horizontal direction. For example, a light source of the auxiliary lighting module 2 can be activated at a dimmed level, so that the illuminance is reduced compared to a curve lighting function of the curve lighting module 2. Thus it is possible for lateral illumination to be adapted to the main lighting function.

### LIST OF REFERENCE SYMBOLS

1 Carrier frame/carrier member

2 Auxiliary lighting module

3 1. Mounting points

4 Reflector

5 2. Mounting points

6 Adjustable mounting point

7 Swivel mounting point

8 Mechanical movement conversion device

9 Linear adjusting element

10 Guide

11 Ball end

12 Ball holder

13 Swivel section

14 Convex contact face

15 Concave contact face

16 Horizontal axis

a Distance

1. A lighting apparatus for vehicles, the apparatus comprising:
a housing containing a main lighting module for creating a specified main lighting function,
an auxiliary lighting module for creating an auxiliary lighting function,
at least one adjusting device for bringing the auxiliary lighting module into an aligned adjustment position, wherein the auxiliary lighting module can be brought into the adjustment position relative to the main lighting module using the adjusting device;
wherein, situated in the adjustment position is a cut-off line for the auxiliary lighting module relative to a cut-off line for the main lighting module; and
wherein the auxiliary lighting module and the main lighting module are fastened to a common carrier member, which is mounted such that it can be swiveled relative to the housing.

2. The lighting apparatus according to claim 1, wherein the adjusting device comprises a mechanical movement conversion device, which has a linear adjusting element, which can be used to adjust the auxiliary lighting module at a mounting point linearly with respect to the carrier member, and which has a swivel mounting point of the auxiliary lighting module arranged at a distance (a) from the mounting point, so that the auxiliary lighting module can be turned in a rotational axis made continuous by the swivel mounting point when the linear adjusting element is activated.

3. The lighting apparatus according to claim 2, wherein the linear adjusting element is linearly guided and mounted in a guide of the carrier member, and in that the linear adjusting element has a ball end that is held in a ball holder of the auxiliary lighting module.

4. The lighting apparatus according to claim 2, wherein the linear adjusting element is designed as a threaded bolt, which is located in a thread engagement with the guide of the carrier member.

5. The lighting apparatus according to claim 1, wherein the auxiliary lighting module and the main lighting module can be synchronously adjusted via the carrier member.

6. The lighting apparatus according to claim 1, wherein the auxiliary lighting module has a dimmable light source, so that when the main lighting module is switched on, its main lighting function is superimposed with the auxiliary lighting function.

7. The lighting apparatus according to claim 1, wherein the auxiliary lighting module is designed as a curve lighting module and wherein the curve lighting module can be switched to the main lighting module, so that when the main lighting module is switched on, its main lighting function is expanded in the horizontal direction.

8. The lighting apparatus according to claim 1, wherein at least one adjusting device is provided for adjusting the carrier member;
and wherein the adjusting device holds on to, first, the housing and, second, the carrier member, so that the carrier member can be swiveled about a horizontal and/or vertical axis.

9. The lighting apparatus according to claim 2, wherein the swivel mounting point of the mechanical movement conversion device is formed by a convex contact face of the auxiliary lighting module and/or by a concave contact face of the carrier member.

10. The lighting apparatus according to claim 3, wherein the guide of the carrier member is formed by a sleeve-like threaded part, which is firmly connected to the carrier member.
